(19) United States
(12) Patent Application Publication
(10) Pub. No.: US 2008/0005509 A1
(43) Pub. Date: Jan. 3, 2008

(54) CACHING RECOVERY INFORMATION ON A LOCAL SYSTEM TO EXPEDITE RECOVERY

(75) Inventors: James P. Smith, Redwood City, CA (US); Neeta Garimella, San Jose, CA (US); Delbert B. Hoobler, Horseheads, NY (US)

Correspondence Address: CANADY & LORTZ LLP- IBM, 2540 HUNTINGTON DRIVE, SUITE 205, SAN MARINO, CA, 91108, US

(73) Assignee: International Business Machines Corporation, San Jose, CA (US)

(21) Appl. No.: 11/428,337

(22) Filed: Jun. 30, 2006

(51) Int. Cl. G06F 12/16

(52) U.S. Cl. 711/162

(57) ABSTRACT

A distributed backup system for a networked computer system is disclosed such that when a data backup is created, a client backup application stores backup restore information as part of the backup data which can be interpreted by the backup application and/or backup server to direct how the remainder of the backup data needs to be restored. The backup restore information may be stored (cached) in staging directory, e.g. on the local computer system. During a backup restore process, the backup application first whether the backup restore information exist in the staging directory before requesting them from the backup server. The backup restore information may be stored in a unique location within the staging directory, e.g. a timestamp-labeled subdirectory. The backup application reconciles the staging directory to eliminate backup restore information for backup data that no longer exists on the backup server.

### BACKGROUND OF THE INVENTION

1. Field of the Invention

This invention relates to networked computer systems. Particularly, this invention relates to performing backup and restore of data in a computer system, such as a networked storage management system.

2. Description of the Related Art

Backup and restore applications have been developed to employ various techniques in order to expedite data recovery time. For example, in systems that employ hierarchical storage management systems, data can be staged from slower storage (e.g. tape storage) to faster storage (e.g. disk storage) in order to reduce the amount of time needed to restore data. In such systems where backup data is moved throughout different storage media, the backup application cannot predict the order in which files will be restored.

Other techniques have been employed to alleviate these issues. For example, if a backup application needs to restore a parent directory and a file located in that parent directory, and the backup server returns the file first, the backup application may simply create a skeleton directory as a placeholder. When the backup server returns the actual parent directory, the skeleton directory is then replaced by the read parent directory.

Another technique to ensure restore order is to aggregate the data into a single backup object from the backup application. When the aggregated data is restored, the data can be recovered in the same sequence as the backup. While this can resolve the ordering problem, it defeats the purpose of the backup server managing the files by placing the management at the local backup application (i.e. on the local machine where the backup application executes).

In addition, there are situations where it is not possible to create skeleton entities which will later be filled in by real data, or where aggregation of data is not possible. One such case is when creating backups that involve a hardware copy image (e.g., such as with a FlashCopy). A distinct set of data (i.e. backup metadata information or backup restore information) is needed to describe how logical file systems are to be created on top of physical copies of disk storage. This includes information pertaining to how logical volumes are defined on the physical media and how file systems are defined on the logical volumes. (Note that describing how a logical file system is to be created may also encompass describing how a logical volume is to be created.) In a system where application data was backed-up using a hardware copy technique and where the system is restoring the application data from the local hardware (e.g., FlashCopy), the metadata information must be applied after the hardware copy of the data is performed. In systems where the application data was backed-up using a hardware copy technique and the data was stored onto a backup server (e.g., onto tape media) the metadata information must be examined before the restoration of data from the backup application server because the metadata information provides the instructions to perform the restoration.

Another backup technique may store instructions on how to restore application data (backup metadata information) with the application data backup in a particular format. An example of this is the Microsoft Volume Shadow Copy Services (VSS) backup method where the backup application must store backup metadata information in XML format with the backup data. Extensible markup language (XML) is well known in the art allowing various information and services to be encoded for computer systems with meaningful structure and semantics that computers and humans can interpret. At restore time, the backup application must first restore this XML data to provide instructions on how the remainder of the data needs to be restored.

With the absence of any of the aforementioned techniques, the backup application is forced to restore data in a two-phase approach, first restoring the metadata instruction set (e.g., XML restore instructions) and then restoring the actual data according to the instruction set. If this data is stored on a tape and non-sequentially, this may often result in an inefficient restore process as tapes may be “thrashed”, i.e., needlessly rewound or unmounted to satisfy the two restore phases. Other techniques for recalling stored data including backup data have also been developed.

U.S. Patent Application Publication No. 2004/0205060 by Viger et al., published Oct. 14, 2004, discloses an access method comprising the following steps: selecting a first data item in a digital document designated by a predetermined identifier, said digital document comprising at least first and second data items linked to each other in a chosen hierarchical relationship; verifying the presence of at least one address of a location containing said second data item of the digital document in storage means of the client device; in the absence of said address in said storage means, seeking said address in the network; in the event of a positive search, storing said address in the storage means of the client device; and subsequently accessing said second data item of the document from the address thus stored by anticipation and thus immediately available locally.

U.S. Pat. No. 6,725,421 by Boucher et al., issued Apr. 20, 2004, discloses various embodiments of an invention providing increased speed and decreased computer processing for playing and navigating multimedia content by using two types of data objects for displaying the multimedia content. The first data object type includes rendered multimedia content data for a rendered cache, or rendering instructions for a paint stream cache or a layout cache. The paint stream cache and layout cache can take advantage of increased client processing capabilities. The second data object type provides semantic content corresponding to the rendered multimedia content. The storage medium in which these two types of data objects are contained is referred to as a rendered cache. The semantic content can include locations, sizes, shapes, and target universal resource identifiers of hyperlinks, multimedia element timing, and other content play instructions. The very fast play of content stored in the rendered cache is due to the elimination of the steps of laying out the content, rendering the content, and generating the semantic representation of the content. These steps are required each time the content is played after retrieval from a conventional cache. The only steps required for playing content from the rendered cache are to read the rendered content, read the semantic content, restore the semantic representation, and play the content. The caching mechanism provided by various embodiments of the invention is independent of content file format and the stored semantic content file format.

U.S. Patent Application Publication No. 2002/0010798 by Ben-Shaul et al., published Jan. 24, 2002, discloses a technique for centralized and differentiated content and application delivery system allows content providers to directly control the delivery of content based on regional and temporal preferences, client identity and content priority. A scalable system is provided in an extensible framework for edge services, employing a combination of a flexible profile definition language and an open edge server architecture in order to add new and unforeseen services on demand. In one or more edge servers content providers are allocated dedicated resources, which are not affected by the demand or the delivery characteristics of other content providers. Each content provider can differentiate different local delivery resources within its global allocation. Since the per-site resources are guaranteed, intra-site differentiation can be guaranteed. Administrative resources are provided to dynamically adjust service policies of the edge servers.

U.S. Patent Application Publication No. 2005/0144200 by Hesselink et al., published Jun. 30, 2005, discloses applications, systems and methods for backing up data include securely connecting at least first and second privately addressed computers over a network, wherein at least one of the computers is connectable to the network through a firewall element. At least a portion of a first version of a file is sent from the first computer to the second computer. The file or portion of a file sent from the first computer is compared with a corresponding version of the file or portion stored at the location of the second computer, and at least one of the versions is saved at the location of the second computer. Systems, applications, computer readable media and methods for providing local access to remote printers, including connecting remote printers over a wide area network to a user computer; displaying an indicator including at least one of a graphical indicator and text for each remote printer that is connected, on a display associated with the user computer; selecting an indicator for the remote printer that is to be printed to; and printing a file stored locally on a local storage device associated with the user computer at the remote printer; wherein at least one of said user computer and the selected remote printer is located behind a firewall, respectively.

U.S. Pat. No. 6,381,674 by DeKoning et al., issued Apr. 30, 2002, discloses an apparatus and methods which allow multiple storage controllers sharing access to common data storage devices in a data storage subsystem to access a centralized intelligent cache. The intelligent central cache provides substantial processing for storage management functions. In particular, the central cache of the present invention performs RAID management functions on behalf of the plurality of storage controllers including, for example, redundancy information (parity) generation and checking as well as RAID geometry (striping) management. The plurality of storage controllers (also referred to herein as RAID controllers) transmit cache requests to the central cache controller. The central cache controller performs all operations related to storing supplied data in cache memory as well as posting such cached data to the storage array as required. The storage controllers are significantly simplified because the present invention obviates the need for duplicative local cache memory on each of the plurality of storage controllers. The storage subsystem of the present invention obviates the need for inter-controller communication for purposes of synchronizing local cache contents of the storage controllers. The storage subsystem of the present invention offers improved scalability in that the storage controllers are simplified as compared to those of prior designs. Addition of storage controllers to enhance subsystem performance is less costly than prior designs.

The central cache controller may include a mirrored cache controller to enhance redundancy of the central cache controller. Communication between the cache controller and its mirror are performed over a dedicated communication link.

In view of the foregoing, there is a need in the art for systems and methods to further enhance backup restore time of a data backup in a computer system. There is further a need for such systems and methods applied to networked storage and distributed data backup systems employing a backup server. These and other needs are met by the present invention as detailed hereafter.

### SUMMARY OF THE INVENTION

Embodiments of the invention can operate as part of a distributed backup system for a networked computer system. A backup server is accessed by one or more client backup applications, each operating on a local computer system, to create data backups on the distributed backup system. When a data backup is created, a client backup application stores backup restore information (i.e. backup recovery information) as part of the backup data which can be interpreted by the backup application and/or backup server to direct how the remainder of the backup data needs to be restored. The backup restore information may be stored (cached) in staging directory, e.g. on the local computer system. During a backup restore process, the backup application first determines whether the backup restore information exist in the staging directory before requesting them from the backup server. The backup restore information may be stored in a unique location within the staging directory, e.g. a timestamp-labeled subdirectory. The backup application can reconcile the staging directory to eliminate backup restore information for backup data that no longer exists on the backup server.

A typical embodiment of the invention comprises a computer program embodied on a computer readable medium, including program instructions for checking whether backup restore information for a data backup exists in a local backup staging directory of a backup server and program instructions for restoring the data backup using the backup restore information from the local backup staging directory without obtaining the backup restore information from the backup server. The data backup is managed by the backup server across a distributed backup system. For example, the backup restore information may comprise one or more XML files comprising instructions for restoring the data backup, for example. The backup restore information may be stored within a unique subdirectory within the local backup staging directory. For example, the unique subdirectory within the local backup staging directory may comprise a timestamp-labeled subdirectory.

In some embodiments, the data backup can comprise a plurality of backup versions each having corresponding distinct backup restore information. Further, the backup restore information may comprise backup metadata describing how a logical file system is to be created on a physical copy of disk storage. In many cases, the data backup may comprise a hardware copy image. However, there are cases where the backup server is only used to backup the backup restore information and not a hardware copy image. In these situations, the data backup includes only the backup restore information and not a hardware copy image. However, the data backup may comprise a plurality of backup objects and the backup restore information may comprise separate metadata for each of the plurality of backup objects.

Further embodiments of the invention may include program instructions for applying and checking a digital signature on the backup restore information in the local backup staging directory. Embodiments of the invention may also include program instructions for reconciling the local backup staging directory with the backup server by determining whether the data backup no longer exists on the backup server and deleting the backup restore information in the local backup staging directory in response to determining that the data backup no longer exists on the backup server. Reconciling the local backup staging directory with the backup server may be performed upon subsequent data backups.

Similarly, a typical method embodiment of the invention includes the operations of checking whether backup restore information for a data backup exists in a local backup staging directory of a backup server and restoring the data backup using the backup restore information from the local backup staging directory without obtaining the backup restore information from the backup server. The data backup is managed by the backup server across a distributed backup system. Method embodiments of the invention can be further modified consistent with the computer program and/or system embodiments of the invention described herein.

### BRIEF DESCRIPTION OF THE DRAWINGS

Referring now to the drawings in which like reference numbers represent corresponding parts throughout:

FIG. 1 is a functional block diagram of an exemplary embodiment of the invention;

FIG. 2A illustrates an exemplary computer system that can be used to implement embodiments of the present invention;

FIG. 2B illustrates a typical distributed computer system which may be employed in an typical embodiment of the invention; and

FIG. 3 is a flowchart of an exemplary method of the invention.

### DETAILED DESCRIPTION OF THE PREFERRED EMBODIMENT

1. Overview

As previously mentioned, embodiments of the invention can operate as part of a distributed data backup system for a networked computer system. In such a distributed data backup system, a backup server may be accessed by one or more client backup applications, each operating on a local computer system, to create data backups on the distributed backup system. When a data backup is created, a client backup application stores backup restore information as part of the backup data which can be interpreted by the backup application and/or backup server to direct how the remainder of the backup data needs to be restored.

Importantly, embodiments of the present invention allow the backup restore information to be employed directly from a staging directory where they are cached that may exist on the local computer system. During a backup restore process, the backup application first determines whether the backup restore information exist in the staging directory before requesting them from the backup server. The backup restore information may be stored in a unique location within the staging directory, e.g. a timestamp-labeled subdirectory. The backup application can reconcile the staging directory to eliminate backup restore information for backup data which no longer exists on the backup server.

2. Caching Backup Restore Information on a Local System

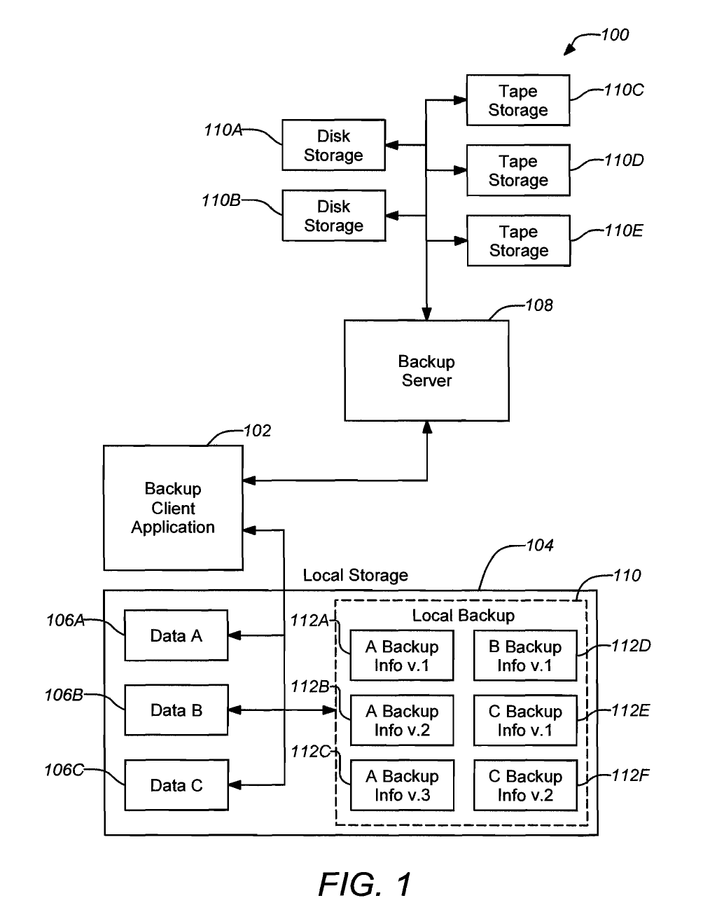

FIG. 1 is a functional block diagram of an exemplary embodiment of the invention. The exemplary storage area network (SAN) 100 operates with a local backup client application 102 operating on a local system which coordinates and requests backup up and restoring one or more data objects 106A-106C on a local storage 104 with a remotely located backup server 108. The local storage 104 can include one or more logical and/or physical storage devices of any type (e.g. hard disk, flash memory, etc.) for storing data on the local system. The data objects 106A-106C may comprise application data such as database data of any type or any other data used by the local computer system alone or as part of a distributed software application such as a e-mail or networked database. In general, the backup server 108 manages the backup storage of data objects 106A-106C to a group of remote storage resources 110A-110E which may include a range of different storage types having different properties which may be selected based upon the particular requirements for a give backup. For example, a data object backup that needs to be quickly accessible may be stored on quick disk storage 110A-110B, whereas a data object backup less likely to be needed or older may be stored on tape storage 110C-110E.

In addition, as part of the ordinary backup and restore processes, some or all of the data objects 106A-106C to be backed up may be stored in a local backup 108 as coordinated between the backup client application 102 and the backup server 106. Embodiments of the present invention recognize that to properly restore some data objects 106A-106C particular backup restore information 112A-112F (e.g. backup metadata such as in XML), which is added to the backup data when the backup is made, may be required first to provide instructions for the proper structure the restored data objects 106A-106C. Accordingly, embodiments of the invention inspect the local backup 110 to first determine whether the backup restore information 112A-112F for the particular backup object 106A-106C exists there. If the required backup restore information 112A-112F is found in the local backup 108, there is no need to retrieve the same information from the remote storage resources 110A-110E through the backup server 108 which will tax the system and delay the overall restore operation.

Operation of an embodiment of the invention may be enhanced by identifying and organizing the backup restore information 112A-112F when a backup is made. First, for each backup of a particular data object 106A-106C, the corresponding backup restore information 112A-112F is uniquely identified within the local backup 108. For example, a timestamp-labeled subdirectory may be created to store the particular backup restore information 112A-112F on the local storage, although any other known technique for generating a unique identifier may also be employed. It is important to note that the unique identifier can distinguish between separate backup objects 106A-106C which may each have different restore requirement although together they are part of a single backup. For example, backup restore information 112A, 112D, 112E stored in the local backup 110 are used to restore data objects 106A, 106B, 106C, respectively. In addition, the unique identifiers can also serve to distinguish between different backup versions of the same backup object. For example, three different backup versions of data object 106A correspond to backup restore information 112A-112C stored in the local backup 110. Similarly, two backup versions of data object 106C correspond to backup restore information 112E, 112F, although only one backup version of data object 106B is described in backup restore information 112D. The unique identifier may be stored on a database of the backup server 108 for quick retrieval to be available when a backup restore is requested.

In addition, to providing a unique identifier to the backup restore information 112A-112F stored locally, a digital signature may also be applied to (or determined from) piece of backup restore information 112A-112F when a backup of a data object 106A-106C is mad. The digital signature may also then be stored in a database on the backup server 108 (or locally) and used to check the backup restore information 112A-112F during a restore. This can secure the backup restore information 112A-112F from any corruption.

During the usual process of performing data backups and restoring, it is important to delete any backup restore information 112A-112F which may still exist in the local backup when a corresponding backup no longer exists on the backup server. Accordingly, backup restore information 112A-112F in the local backup 110 may be periodically reconciled with the existing backups for the local system shown on the backup server 108. For example, this reconciliation may occur at each subsequent backup request and any extraneous backup restore information 112A-112F deleted. Without this process, the contents of the local backup 110 would continue to increase indefinitely over time.

In one specific example, an embodiment of the invention may be applied to the Microsoft Volume Shadow Copy Services (VSS) backup method, previously mentioned. In this case, the local backup client application for a Tivoli Storage Manager (TSM) backup server stores the XML files (the backup restore information such as backup metadata information) in a known location, a staging directory, and backs up these files along with the remainder of the backup data. Upon a backup restore process, these XML files are restored first and then a second pass is made to restore the rest of the data. It is often the case that at restore time the XML information might still be in the local staging directory and could be used directly instead of restoring the information from the backup server. Embodiments of the invention allow the backup application to determine if the files exist on the local system before requesting them from the backup server. If they XML information does exist in the local staging directory and they can be retrieved from there, the overall speed of the restore proces is improved. Embodiments of the invention may incorporate one or more of a variety of techniques to operate effectively.

For example, several backup versions can be made for the same file or application data. Instead of writing the files to a common location, each backup version stores its XML files in a unique section of a known location, e.g., a subdirectory within the staging directory which is named with a backup time stamp. The backup time stamp may be recorded as part of the backup operation. However, the backup application should remove these XML files (e.g. through a regularly performed reconciliation) if there is no longer a corresponding entry on the backup server. If this operation is not performed, the local cache of XML files in the staging directory will grow indefinitely. In addition, the local cache of XML files should be protected by using a digital signature to ensure that the contents are not changed or deleted.

For example, a digital signature (e.g. such as a checksum) can be derived from one or more metadata information files (e.g. one or more XML files) and then stored in the backup server database. In order to verify viability of the metadata information in the local cache at any later time (e.g. during a regular reconcilation with the backup server), the current checksum value of the applicable metadata information file(s) can be compared to the corresponding digital signature from backup server database.

Embodiments of the invention provide several advantages over applicable prior art distributed backup systems. Ordinarily, if the backup server is be used to restore data stored on local media such as a local FlashCopy, some metadata information (e.g. XML files) needs to be stored on the TSM backup server. However, with embodiments of the invention, all of the backup metadata information can be restored locally from the cache, including the metadata that is also stored on the TSM server.

In general, with a FlashCopy, just a copy of physical media is taken, i.e., only the data bits without any context. If the FlashCopy is only a local copy the local physical copy may be all that is required. However, in a backup to a TSM server, the backup is occurring at the file system level (i.e. images of file systems). Thus, there are two typical types of restores: a local FlashCopy restore where additional file information metadata defines the logical volumes and file systems or a typical restore from TSM server where the metadata information is read and defines the logical volumes and file systems and then restores the files system data. This describes a distinction between conventional TSM server backups and conventional hardware backups (like a FlashCopy). However, more recently hardware backups (like FlashCopy) may also be managed by the TSM server. Embodiments of the invention are applicable to backup servers managing all types of backup processes, e.g. hardware and file system level.

A backup request may store several disparate pieces of metadata which can exesterbate the restore request. For example, the tape layout of the data on the backup server (e.g. a TSM server) could comprise metadata for a first backup object, the real data for the first backup object, metadata for a second backup object, the real data for the second backup object, and so on. Embodiments of the invention can greatly reduce the need to position the tape several times in systems where all the backup information metadata must be restored before the actual backup data is restored. In addition, operation of the invention can be independent of where files are ultimately stored on the backup server (TSM server); operation is independent of media type, tape placement, and other similar factors.

3. Hardware Environment

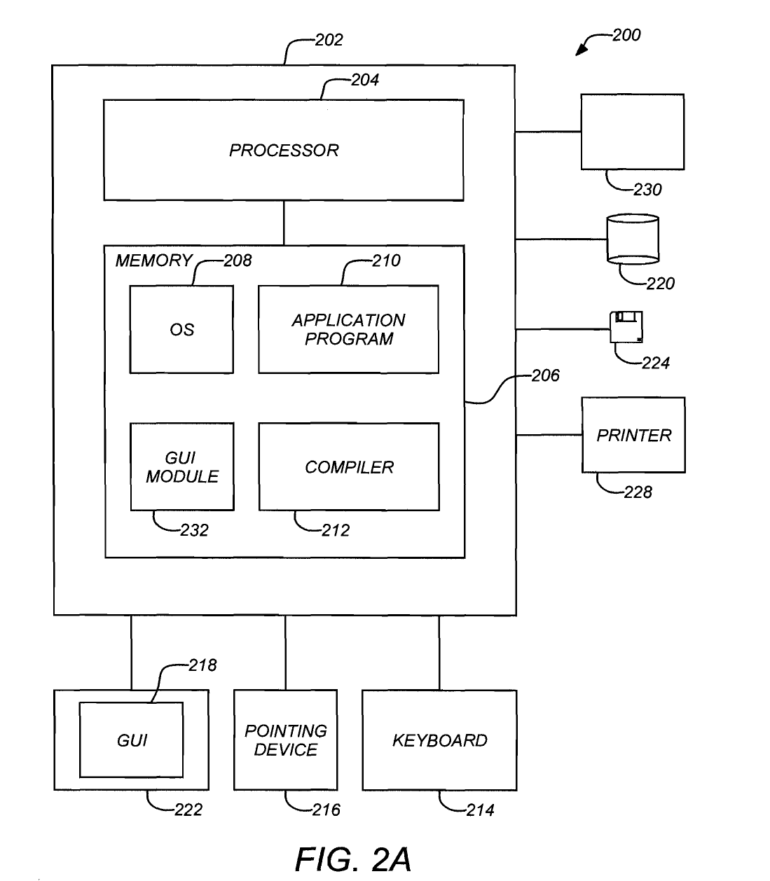

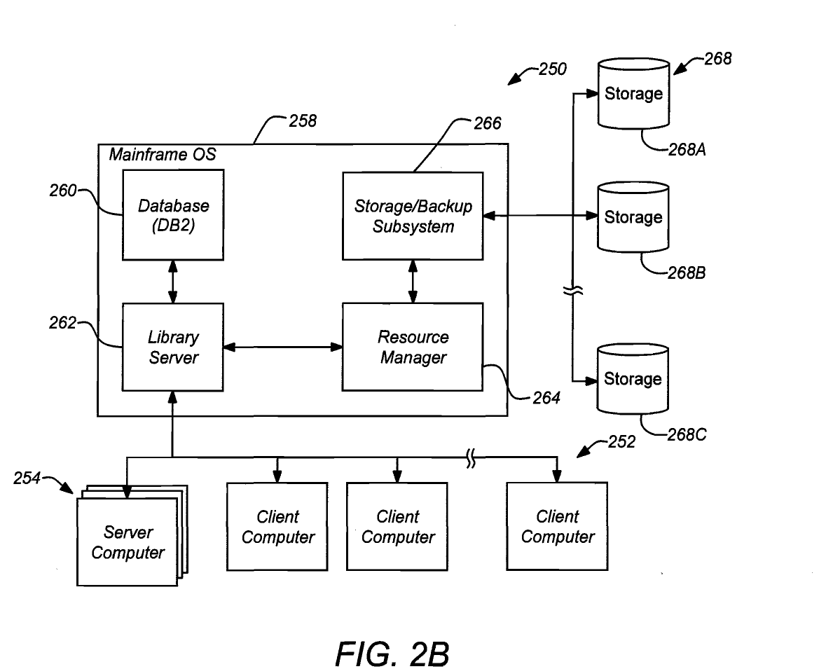

FIG. 2A illustrates an exemplary computer system 200 that can be used to implement embodiments of the present invention. The computer 202 comprises a processor 204 and a memory 206, such as random access memory (RAM). The computer 202 is operatively coupled to a display 222, which presents images such as windows to the user on a graphical user interface 218. The computer 202 may be coupled to other devices, such as a keyboard 214, a mouse device 216, a printer, etc. Of course, those skilled in the art will recognize that any combination of the above components, or any number of different components, peripherals, and other devices, may be used with the computer 202.

Generally, the computer 202 operates under control of an operating system 208 (e.g. z/OS, OS/2, LINUX, UNIX, WINDOWS, MAC OS) stored in the memory 206, and interfaces with the user to accept inputs and commands and to present results, for example through a graphical user interface (GUI) module 232. Although the GUI module 232 is depicted as a separate module, the instructions performing the GUI functions can be resident or distributed in the operating system 208, a computer program 210, or implemented with special purpose memory and processors.

The computer 202 also implements a compiler 212 which allows one or more application programs 210 written in a programming language such as COBOL, PL/1, C, C++, JAVA, ADA, BASIC, VISUAL BASIC or any other programming language to be translated into code that is readable by the processor 204. After completion, the computer program 210 accesses and manipulates data stored in the memory 206 of the computer 202 using the relationships and logic that was generated using the compiler 212. The computer 202 also optionally comprises an external data communication device 230 such as a modem, satellite link, ethernet card, wireless link or other device for communicating with other computers, e.g. via the Internet or other network.

Instructions implementing the operating system 208, the computer program 210, and the compiler 212 may be tangibly embodied in a computer-readable medium, e.g., data storage device 220, which may include one or more fixed or removable data storage devices, such as a zip drive, floppy disc 224, hard drive, DVD/CD-rom, digital tape, etc., which are generically represented as the floppy disc 224. Further, the operating system 208 and the computer program 210 comprise instructions which, when read and executed by the computer 202, cause the computer 202 to perform the steps necessary to implement and/or use the present invention. Computer program 210 and/or operating system 208 instructions may also be tangibly embodied in the memory 206 and/or transmitted through or accessed by the data communication device 230. As such, the terms “article of manufacture,” “program storage device” and “computer program product” as may be used herein are intended to encompass a computer program accessible and/or operable from any computer readable device or media.

Embodiments of the present invention are generally directed to any software application program 210 that manages backup storage and restore processes over a network. The program 210 may operate within a single computer 202 or as part of a distributed computer system comprising a network of computing devices. The network may encompass one or more computers connected via a local area network and/or Internet connection (which may be public or secure, e.g. through a VPN connection).

FIG. 2B illustrates a typical distributed computer system 250 which may be employed in an typical embodiment of the invention. Such a system 250 comprises a plurality of computers 202 which are interconnected through respective communication devices 230 in a network 252. The network 252 may be entirely private (such as a local area network within a business facility) or part or all of the network 252 may exist publicly (such as through a virtual private network (VPN) operating on the Internet). Further, one or more of the computers 202 may be specially designed to function as a server or host 254 facilitating a variety of services provided to the remaining client computers 256. In one example one or more hosts may be a mainframe computer 258 where significant processing for the client computers 256 may be performed. The mainframe computer 258 may comprise a database 260 which is coupled to a library server 262 which implements a number of database procedures for other networked computers 202 (servers 254 and/or clients 256). The library server 262 is also coupled to a resource manager 264 which directs data accesses through storage/backup subsystem 266 that facilitates accesses to networked storage devices 268 comprising a SAN. Thus, the storage/backup subsystem 266 on the computer 262 comprise the backup server for the distributed storage system, i.e. the SAN. The SAN may include devices such as direct access storage devices (DASD) optical storage and/or tape storage indicated as distinct physical storage devices 268A-268C. Various known access methods (e.g. VSAM, BSAM, QSAM) may function as part of the storage/backup subsystem 266.

Those skilled in the art will recognize many modifications may be made to this hardware environment without departing from the scope of the present invention. For example, those skilled in the art will recognize that any combination of the above components, or any number of different components, peripherals, and other devices, may be used with the present invention meeting the functional requirements to support and implement various embodiments of the invention described herein.

4. Example Process of Caching Backup Restore Information

In an example process illustrating an embodiment of the invention, a user first requests a backup of an application, e.g., a backup of an Microsoft Exchange storage group or groups, with a backup client application running on a local system. The backup client application determines that the backup can be accomplished with a system such VSS which requires the backup of metadata information in XML format (the backup restore information). The backup client application then creates a timestamp, e.g., 20050825153030, for the backup and stores it on the backup server. This information is also stored in the backup server database for fast retrieval.

The backup client application generates the XML documents; instead of writing them to a common file or subdirectory, e.g., c:\adsm.sys, it writes them to a unique staging subdirectory on the local system identified by the timestamp, e.g., c:\adsm.sys\20050825153030. A digital signature may also be created by taking information such as file size and number of files into account or some other mechanism which guards against files being deleted or changed. During a subsequent backup operation, a reconciliation process with the backup server can determine (from the backup server database) whether the backup server still has a backup with a timestamp of 20050825153030. If so, the backup client application leaves the unique staging subdirectory (c:\adsm.sys\20050825150303) in place. If the backup server no longer includes a backup with the timestamp, the backup client application deletes the unique staging subdirectory within the staging area on the local system.

When a backup restore is requested, the backup client application retrieves the backup timestamp from the backup server; if the staging directory (c:\adsm.sys\20050825150303) is in place and the digital signature is correct, the backup application skips restoring these files from the backup server as they are readily available from the unique staging subdirectory on the local system.

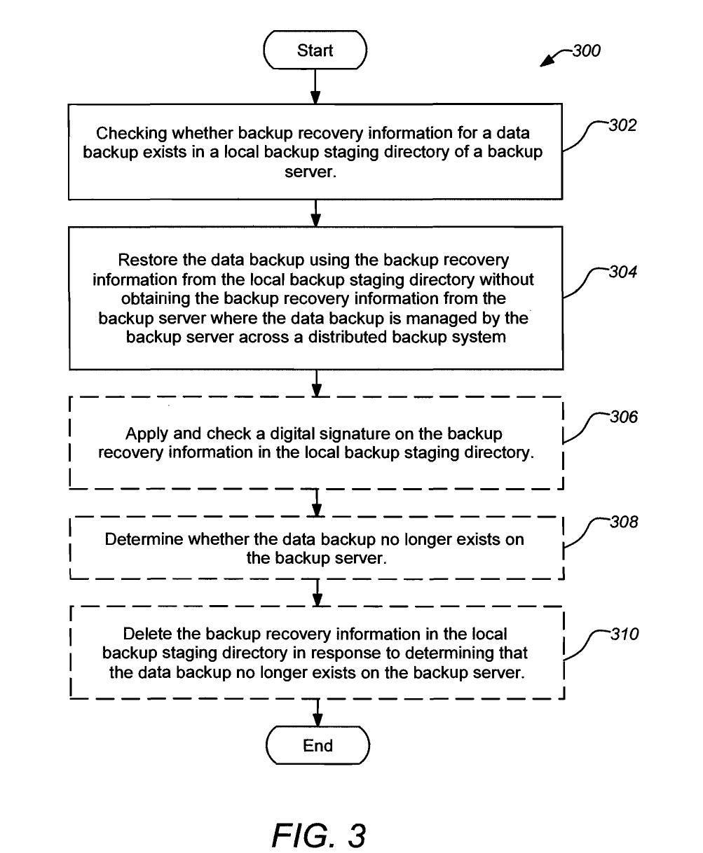

FIG. 3 is a flowchart of an exemplary method 300 of the invention. The method 300 begins with an operation 302 by checking whether backup recovery information for a data backup exists in a local backup staging directory of a backup server. Next, in operation 304 the data backup is restored using the backup recovery information from the local backup staging directory without obtaining the backup recovery information from the backup server where the data backup is managed by the backup server across a distributed backup system. The method 300 may optionally include an operation 306 comprising applying and checking a digital signature on the backup recovery information in the local backup staging directory. This operation 306 can protect the backup recovery information against deletion or alteration.

In addition, the method 300 may further include optional operations for reconciling the local backup staging directory with the backup server by determining whether the data backup no longer exists on the backup server in operation 308 and deleting the backup recovery information in the local backup staging directory in response to determining that the data backup no longer exists on the backup server in operation 310. Reconciling of the local backup staging directory with the backup server is typically performed upon a subsequent data backup. As previously mentioned, method embodiments of the invention can be further modified consistent with the computer program and/or system embodiments of the invention described herein.

This concludes the description including the preferred embodiments of the present invention. The foregoing description including the preferred embodiment of the invention has been presented for the purposes of illustration and description. It is not intended to be exhaustive or to limit the invention to the precise forms disclosed. Many modifications and variations are possible within the scope of the foregoing teachings. Additional variations of the present invention may be devised without departing from the inventive concept as set forth in the following claims.

What is claimed is:

1. A computer program embodied on a computer readable medium, comprising:
program instructions for checking whether backup restore information for a data backup exists in a local backup staging directory of a backup server; and
program instructions for restoring the data backup using the backup restore information from the local backup staging directory without obtaining the backup restore information from the backup server;
wherein the data backup is managed by the backup server across a distributed backup system.

2. The computer program of claim 1, wherein the data backup comprises a plurality of backup versions each having corresponding distinct backup restore information.

3. The computer program of claim 1, wherein the backup restore information comprises backup metadata describing how a logical file system is to be created on a physical copy of disk storage.

4. The computer program of claim 3, wherein the data backup comprises a hardware copy image on the backup server.

5. The computer program of claim 1, wherein the data backup comprise a plurality of backup objects and the backup restore information comprises separate metadata for each of the plurality of backup objects.

6. The computer program of claim 1, further comprising program instructions for applying and checking a digital signature on the backup restore information in the local backup staging directory.

7. The computer program of claim 1, further comprising program instructions for reconciling the local backup staging directory with the backup server by:
determining whether the data backup no longer exists on the backup server; and
deleting the backup restore information in the local backup staging directory in response to determining that the data backup no longer exists on the backup server.

8. The computer program of claim 7, wherein reconciling the local backup staging directory with the backup server is performed upon a subsequent data backup.

9. The computer program of claim 1, wherein the backup restore information is stored within a unique subdirectory within the local backup staging directory.

10. The computer program of claim 9, wherein the unique subdirectory within the local backup staging directory comprises a timestamp-labeled subdirectory.

11. A method comprising:
checking whether backup restore information for a data backup exists in a local backup staging directory of a backup server; and
restoring the data backup using the backup restore information from the local backup staging directory without obtaining the backup restore information from the backup server;
wherein the data backup is managed by the backup server across a distributed backup system.

12. The method of claim 11, wherein the data backup comprises a plurality of backup versions each having corresponding distinct backup restore information.

13. The method of claim 11, wherein the backup restore information comprises backup metadata describing how a logical file system is to be created on a physical copy of disk storage.

14. The method of claim 13, wherein the data backup comprises a hardware copy image on the backup server.

15. The method of claim 11, wherein the data backup comprise a plurality of backup objects and the backup restore information comprises separate metadata for each of the plurality of backup objects.

16. The method of claim 11, further comprising applying and checking a digital signature on the backup restore information in the local backup staging directory.

17. The method of claim 11, further comprising reconciling the local backup staging directory with the backup server by:
determining whether the data backup no longer exists on the backup server; and
deleting the backup restore information in the local backup staging directory in response to determining that the data backup no longer exists on the backup server.

18. The method of claim 17, wherein reconciling the local backup staging directory with the backup server is performed upon a subsequent data backup.

19. The method of claim 11, wherein the backup restore information is stored within a unique subdirectory within the local backup staging directory.

20. The method of claim 19, wherein the unique subdirectory within the local backup staging directory comprises a timestamp-labeled subdirectory.
